(19) United States
(12) Patent Application Publication
(10) Pub. No.: US 2011/0042850 A1
(43) Pub. Date: Feb. 24, 2011

(54) Method of manufacturing plastic surface with superhydrophobicity and high transparency

(75) Inventors: Chien-Chong Hong, Zhubei City (TW); Pin Huang, Douliu City (TW); Jiann Shieh, Zhubei City (TW)

Correspondence Address: BACON & THOMAS, PLLC, 625 SLATERS LANE, FOURTH FLOOR, ALEXANDRIA, VA, 22314-1176, US

(73) Assignee: National Tsing Hua University

(21) Appl. No.: 12/654,224

(22) Filed: Dec. 15, 2009

(30) Foreign Application Priority Data
Aug. 20, 2009 (TW) 098128022

(51) Int. Cl. B29C 59/02

(52) U.S. Cl. 264/293; 977/887

(57) ABSTRACT

A method of manufacturing a plastic surface with superhydrophobicity and high transparency is disclosed. In this method, a thermal nanoimprinting mold method is used to form a plurality of sub-20 nm nanograss structure on a surface of a cyclic-olefin copolymer (COC) material, so that the surface can have superhydrophobicity and high transparency at the same time.

### BACKGROUND OF THE INVENTION

1. Field of the Invention

The present invention relates to surface modification, and more particularly, to a method of manufacturing a plastic surface with superhydrophobicity and high transparency.

2. Description of the Prior Art

In recent years, no matter in the country or overseas, there are numerous researches related to the surface treatment or the surface modification. The coverage of the surface treatment region is very wide ranging from the traditional industries to the current high technology industries, from the metal surface in the past to the plastic or nonmetal surface currently. The surface-treated material can be more corrosion-resisting, wear-resisting, heat-resistant, and its using life can be also extended. Additionally, the extra value of the product can be also increased by improving its characteristics, luster, and appearance via the surface treatment.

The processing technologies for changing the physical, mechanical, and chemical properties of the material surface mentioned above are called surface treatment or surface processing, wherein the researches and applications related to the superhydrophobicity of the object surface are very popular, and many good results have been already obtained.

In general, the method used in common to form a plastic surface with superhydrophobicity is to perform a chemical coating or a plasma treatment to the plastic surface, or to treat the plastic surface with micrometer structure via the above-mentioned methods.

However, the superhydrophobicity of the plastic surface formed by these methods can not maintain a long period of time. Furthermore, although the plastic surface has superhydrophobicity via the above-mentioned methods, the transparency of the plastic surface is usually poor. Accordingly, the application range of the surface-treated plastic surface will be seriously limited by these two drawbacks and can not be widely used.

Therefore, the invention provides a method of manufacturing a plastic surface with superhydrophobicity and high transparency to solve the aforementioned problems.

### SUMMARY OF THE INVENTION

One embodiment of the invention is a method of manufacturing a plastic surface with superhydrophobicity and high transparency.

In this embodiment, the method forms a plurality of sub-20 nm nanograss structures on a surface of a cyclic-olefin copolymer (COC) material via a thermal nanoimprinting mold method.

In practical applications, in the above-mentioned thermal nanoimprinting mold method, at first, the method heats to a specific temperature to make the COC material to form a melt with good fluidity, then, the method imprints a mold on the surface of the COC material to form the plurality of nanograss structures on the surface. Wherein, the specific temperature is slightly higher than the glass transient temperature of the COC material, so that the COC material can form the melt with good fluidity.

When the mold is imprinted on the surface of the COC material, the melt with good fluidity formed by the COC material will closely fill a plurality of gaps among the plurality of nanograss mold units of the mold, after the unmolding and solidifying process, the plurality of nanograss structures is formed on the surface of the COC material.

Compared with the prior art, the invention is to form sub-20 nm nanograss structures with high aspect ratio on the surface of the COC material, so that the surface of the COC material can have superhydrophobicity and high transparency at the same time.

In particularly, through the manufacturing method of the invention, the surface of the COC material with nanograss structures can reach superhydrophobicity because the contact angle of the surface of the COC material is larger than 155°, and the superhydrophobicity of the surface can maintain several weeks in a solvent solution at 60° C. Additionally, the manufacturing processes used in the invention is quite simple and the manufacturing cost is cheap, therefore, the application range of the invention can be effectively increased and the manufacturing process cost can be also saved to be very competitive in the market.

In view of the rapid developments of the biomedical industries, the MEMS industries, and the environmental protection industries, the products made via the manufacturing method of the invention should satisfy the practical needs of the biomedical industries, the MEMS industries, and the environmental protection industries, for example, the applications of protein absorption, cell culturing, and self-cleaning surface. Therefore, the manufacturing method of the invention is very useful in commercial.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 illustrates a flowchart of the method of manufacturing a plastic surface with superhydrophobicity and high transparency according to an embodiment of the present invention.

FIG. 2(A)˜2(C) illustrate scheme diagrams of the steps of the thermal nanoimprinting mold method used in the invention.

FIG. 3(A) illustrates a scheme diagram of the COC material without sub-20 nm nanograss structures on its surface.

FIG. 3(B) illustrates a scheme diagram of the COC material with sub-20 nm nanograss structures on its surface.

FIG. 4 illustrates the transmittance curves of the surface of the COC material with/without sub-20 nm nanograss structures to the transmitting lights with different wavelengths.

### DETAILED DESCRIPTION OF THE INVENTION

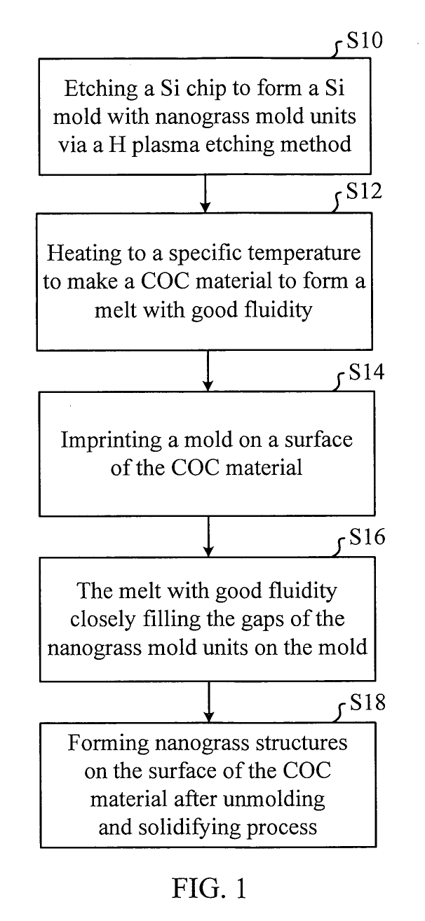

One embodiment of the invention is a method of manufacturing a plastic surface with superhydrophobicity and high transparency. Please refer to FIG. 1. FIG. 1 illustrates a flowchart of the method of manufacturing a plastic surface with superhydrophobicity and high transparency according to an embodiment of the present invention.

As shown in FIG. 1, at first, the method will perform the step S10 for etching a silicon chip to form a silicon mold with nanograss mold units via a hydrogen plasma etching method. In fact, the method can also use other etching methods (e.g., dry etching method such as the reactive ion etching (RIE) method) to etch the silicon chip, not limited to the hydrogen plasma etching method used in this case.

Then, the method will perform the step S12 for heating to a specific temperature to make the COC material to form a melt with good fluidity. In practical applications, the specific temperature used in the method is slightly higher than the glass transient temperature of the COC material.

Foe example, since the glass transient temperature of the COC material is about 150° C., the specific temperature used in the method can be set about 160° C., but not limited to this case.

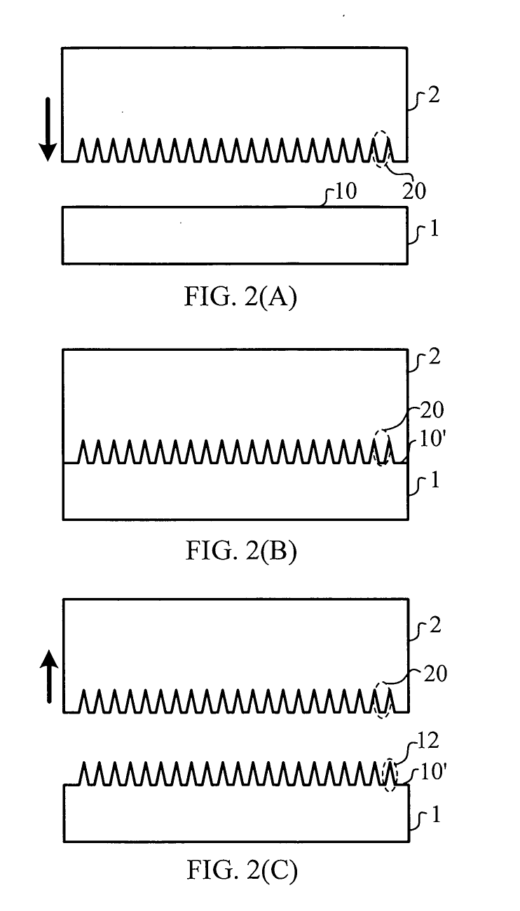

Afterward, please also refer to FIG. 2(A)˜2(C). FIG. 2(A)˜2(C) illustrate scheme diagrams of the steps of the thermal nanoimprinting mold method used in the invention.

After the COC material 1 has already formed the melt with good fluidity, the method will perform the step S14 for imprinting a mold 2 on the surface 10 of the COC material 1. As shown in FIG. 2(A), the mold 2 comprises a plurality of nanograss mold units 20, and the plurality of nanograss mold units 20 all has sub-20 nm size and high aspect ratio.

In fact, the number of the nanograss mold units 20 in the mold 2 and the arranging density of the nanograss mold units 20 can be decided according to the practical needs, there is no specific limitations.

When the mold 2 is imprinted on the surface 10 of the COC material 1, because the surface 1 is pressed by the nanograss mold units 20 of the mold 2, the surface 10 will become the surface 10′, as shown in FIG. 2(B).

Since the COC material 1 has already become the melt with good fluidity, therefore, the method performs the step S16, the melt with good fluidity will closely fill a plurality of gaps among the plurality of nanograss mold units 20 of the mold 2, as shown in FIG. 2(B).

It should be noticed that because the COC material 1 will form the melt with good fluidity at the temperature over its glass transient temperature, with this characteristic, the sub-20 nm nanograss structures with high aspect ratio can be formed on the surface 10′ of the COC material 1.

On the contrary, if other plastic materials with poor melt fluidity are used, the plurality of gaps among the plurality of nanograss mold units 20 of the mold 2 can not be closely filled by the melt with poor fluidity, so that the nanograss structures formed at last have lower aspect ratio and poorer hydrophobicity.

At last, after the melt closely fill the plurality of gaps among the plurality of nanograss mold units 20 of the mold 2, the method performs the step S18, as shown in FIG. 2(C), after the unmolding and solidifying process, the plurality of nanograss structures 12 will be formed on the surface 10′ of the COC material 1.

In practical applications, the number of the plurality of nanograss structures 12 corresponds to the number of the plurality of gaps among the plurality of nanograss mold units 20 of the mold 2, therefore, the number of the plurality of nanograss structures 12 formed on the surface 10′ of the COC material 1 can be adjusted by controlling the number of the nanograss mold units 20 in the mold 2.

For example, if the mold 2 totally comprises 25 nanograss mold units 20, then 24 gaps will be formed among the 25 nanograss mold units 20, therefore, 24 nanograss structures 12 will be formed on the surface 10′ of the COC material 1.

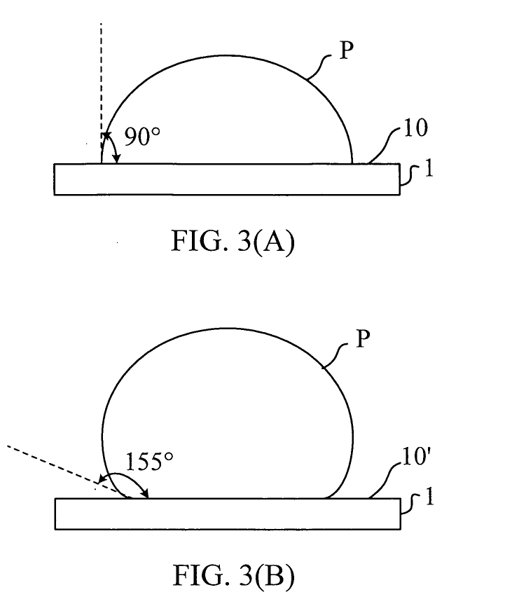

Please refer to FIG. 3(A) and 3(B). FIG. 3(A) illustrates a scheme diagram of the COC material 1 without sub-20 nm nanograss structures on its surface 10; FIG. 3(B) illustrates a scheme diagram of the COC material 1 with sub-20 nm nanograss structures on its surface 10′.

As shown in FIG. 3(A), when a drop P is dropped on the surface 10 of the COC material 1 without nanograss structures, the contact angle between the drop P and the surface 10 is 90°, therefore, the surface 10 without nanograss structures only has ordinary hydrophobicity. As shown in FIG. 3(B), when the drop P is dropped on the surface 10′ of the COC material 1 with sub-20 nm nanograss structures, the contact angle between the drop P and the surface 10′ is 155°, therefore, the surface 10′ with sub-20 nm nanograss structures has superhydrophobicity.

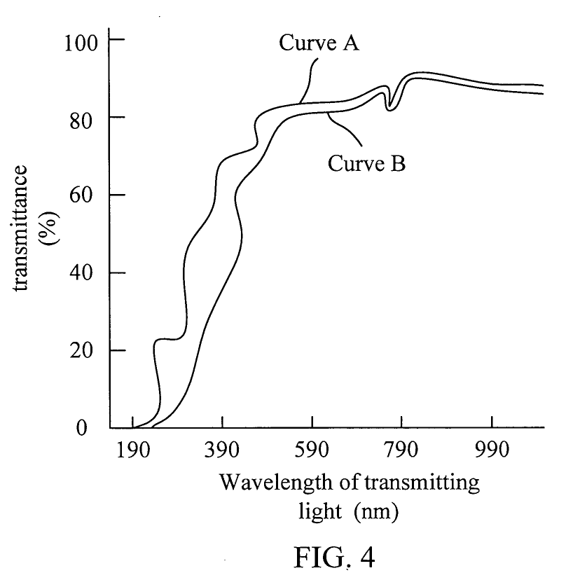

Please refer to FIG. 4. FIG. 4 illustrates the transmittance curves of the surface 10 without nanograss structures and the surface 10′ with nanograss structures of the COC material 1 to the transmitting lights with different wavelengths.

As shown in FIG. 4, curve A represents the transmittance curve of the surface 10′ with nanograss structures of the COC material 1 to the transmitting lights with different wavelengths; curve B represents the transmittance curve of the surface 10 without nanograss structures of the COC material 1 to the transmitting lights with different wavelengths.

Apparently, because the plurality of nanograss structures formed on the surface 10′ has the size of sub-20 nm, the size is small enough that the transmitting lights passing through the COC material 1 will not be blocked, so that the surface 10′ has high transparency. In practical applications, the transmittance of the surface 10′ with nanograss structures for visible lights increases 4%˜6% compared to that of the surface 10 without nanograss structures, but not limited to this case.

Compared with the prior art, the invention is to form sub-20 nm nanograss structures with high aspect ratio on the surface of the COC material, so that the surface of the COC material can have superhydrophobicity and high transparency at the same time.

It should be noticed that through the manufacturing method of the invention, the surface of the COC material with nanograss structures can reach superhydrophobicity because the contact angle of the surface of the COC material is larger than 155°, and the superhydrophobicity of the surface can maintain several weeks in a solvent solution at 60° C. Additionally, the manufacturing processes used in the invention is quite simple and the manufacturing cost is cheap, therefore, the application range of the invention can be effectively increased and the manufacturing process cost can be also saved to be very competitive in the market.

In view of the rapid developments of the biomedical industries, the MEMS industries, and the environmental protection industries, the products made via the manufacturing method of the invention should satisfy the practical needs of the biomedical industries, the MEMS industries, and the environmental protection industries, for example, the applications of protein absorption, cell culturing, and self-cleaning surface. Therefore, the manufacturing method of the invention is very useful in commercial.

Although the present invention has been illustrated and described with reference to the preferred embodiment thereof, it should be understood that it is in no way limited to the details of such embodiment but is capable of numerous modifications within the scope of the appended claims.

What is claimed is:

1. A method of manufacturing a plastic surface with superhydrophobicity and high transparency, comprising the step of:
(a) forming a plurality of sub-20 nm nanograss structures on a surface of a cyclic-olefin copolymer (COC) material via a thermal nanoimprinting mold method.

2. The method of claim 1, wherein the plurality of nanograss structures has high aspect ratio.

3. The method of claim 1, wherein the step (a) comprises the steps of:
(a1) heating to a specific temperature to make the COC material to form a melt with good fluidity; and
(a2) imprinting a mold on the surface of the COC material to form the plurality of nanograss structures on the surface.

4. The method of claim 3, wherein the specific temperature is higher than the glass transient temperature of the COC material.

5. The method of claim 3, wherein the mold comprises a plurality of nanograss mold units, and the plurality of nanograss mold units all has sub-20 nm size and high aspect ratio.

6. The method of claim 5, wherein in the step (a2), when the mold is imprinted on the surface of the COC material, the melt with good fluidity formed by the COC material will closely fill a plurality of gaps among the plurality of nanograss mold units of the mold, after the unmolding and solidifying process, the plurality of nanograss structures is formed on the surface of the COC material.

7. The method of claim 5, wherein the plurality of nanograss mold units of the mold is formed by etching a silicon chip via a hydrogen plasma etching method.

8. The method of claim 1, wherein the plurality of nanograss structures is formed on the surface of the COC material, so that a contact angle of the surface of the COC material is larger than 155° and the surface has superhydrophobicity.

9. The method of claim 8, wherein the superhydrophobicity of the surface can maintain at least one week in a solvent solution at 60° C.

10. The method of claim 1, wherein the surface has high transparency since the light passing through the surface of the COC material is not blocked by the plurality of sub-20 nm nanograss structures formed on the surface of the COC material.

11. The method of claim 10, wherein after the plurality of nanograss structures is formed on the surface of the COC material, the transmittance of the surface for visible lights increases 4%˜6%.
